(19) United States
(12) Patent Application Publication
(10) Pub. No.: US 2006/0290654 A1
(43) Pub. Date: Dec. 28, 2006

(54) Holder for electronic apparatus

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/144,648

(22) Filed: Jun. 6, 2005

(51) Int. Cl. G09G 5/00

(52) U.S. Cl. 345/156

(57) ABSTRACT

The present invention is to provide a holding device comprising a support having its underside attached to a seat and a top surface adapted to hold an electronic apparatus; a shuttle member having one end slidably passed one end of the support; a pivot at the other end of the shuttle member; a magnifying glass having one end pivotally connected to the pivot such that the magnifying glass is adapted to turn a predetermined angle about the pivot; and a catch at one ends of the support and the shuttle member for lockably engaging the shuttle member, for adjusting a distance of the magnifying glass relative to a display of the electronic apparatus on the support and enabling a user to see a magnified, clear display through the magnifying glass.

### FIELD OF THE INVENTION

The present invention relates to holding devices and more particularly to a device having one end attached to a member (e.g., console) of an automobile and the other end with an electronic apparatus (e.g., PDA (personal digital assistant)) firmly held thereon.

### BACKGROUND OF THE INVENTION

The world we are living in has entered into a new era due to rapid progress of electronics and computer technologies. A wide variety of electronic products are available in an even faster pace in recent years. The fast development of electronic products not only brings a lot of convenience but also improves living quality. As a result, such products are closely associated with our daily life and work. An important one of the electronic products is PDA and which is a pocket-sized computer with features such as being compact, lightweight, and fast in processing speed. Moreover, PDA can incorporate features such as notebook, calendar, database, video game, telephone directory, dictionary, graphics, and calculator. As such, more and more people own PDAs in recent years. Thus, PDA manufacturers invest much for continuously developing new models of PDA not only having features of more lightweight, slimmer, and more compact but also having powerful functionalities. In addition, new models of cellular phones are much improved in functionality. Thus, it is impossible of doing without them.

PDA has features similar to that of a typical personal computer. Thus, many people not only use PDA as a PIM (personal information management) but also use PDA in navigation system (e.g., GPS (Global Positioning System)) of an automobile. In a case of a PDA attached to a satellite receiving antenna, the satellite receiving antenna is able to receive signals sent from a plurality of satellites to the Earth so as to determine an exact position of the satellite receiving antenna. Next, map software installed in the PDA can calculate and command the PDA to show the position of the satellite receiving antenna. As such, a PDA user can know his/her exact location in a practically effortless manner. Alternatively, the map software and the satellite receiving antenna can be employed to enable a PDA user to quickly decide route of a proposed journey, plot destination on the map, and navigate. For achieving the purpose of using a PDA as PIM, video game machine, music player, or navigation system by mounting a PDA or cellular phone in an automobile, it is typically required to secure same to a holder. After securing, a user may easily, conveniently use a PDA or cellular phone while driving. Following is a description of a well known holder for serving such purpose.

Referring to FIG. 1, the well known holder 10 comprises a flexible arm 11 having one end formed as a fastening section 12 secured to a suction cup 13. The holder 10 is thus able to mount on any flat surface by means of the suction cup 13. The other end of the arm 11 is formed as a support 14 for firmly holding an electronic apparatus (e.g., a PDA or cellular phone) 15. By configuring as above, for mounting the holder 10 in an automobile, a user may attach the suction cup 13 to a flat portion (e.g., console) of the automobile and firmly place the electronic apparatus 15 on a surface of the support 14. Moreover, an angle of the electronic apparatus 15 relative to the user can be adjusted as desired by manipulating the arm 11.

By configuring as above, the holder 10 is adapted to only provide a support to the electronic apparatus 15 placed thereon. It is understood that the development of an electronic apparatus 15 is toward lightweight, slimness, and compactness. Also, a display 151 of the electronic apparatus 15 is relatively small and thus it is impossible of providing a large screen for user viewing. Thus, a user may often feel inconvenient and be bothered in watching display 151 for understanding his/her exact position, deciding route of a proposed journey, or plotting destination on the map. This is because the user has to not only concentrate on driving but also watch the display 151. The inventor is aware of the above problem and is dedicated to find a solution to the problem. The inventor thus spends a lot of time to devise a holder 10 for electronic apparatus. The holder 10 not only can provide a space for placing an electronic apparatus 15 but also provide a large, clear screen for user viewing through a magnifying glass so as to increase competitiveness on the market of such product.

### SUMMARY OF THE INVENTION

After considerable research and experimentation, a holder for electronic apparatus according to the present invention has been devised so as to overcome the above drawback of the prior art.

It is an object of the present invention to provide a holding device comprising a support having its underside attached to a seat and a top surface adapted to hold an electronic apparatus (e.g., PDA or cellular phone); a shuttle member having one end slidably passed one end of the support; a pivot at the other end of the shuttle member; a magnifying glass having one end pivotally connected to the pivot such that the magnifying glass is adapted to turn a predetermined angle about the pivot; and a catch at one ends of the support and the shuttle member for lockably engaging the shuttle member or not. By utilizing this holding device, it is possible of adjusting a distance of the magnifying glass relative to a display of the electronic apparatus on the support, thereby enabling a user to see a magnified, clear display through the magnifying glass. Moreover, the drawback of the prior holder (e.g., a user is unable to see a magnified, clear display of the electronic apparatus on the support) is substantially eliminated by the present invention.

The above and other objects, features and advantages of the present invention will become apparent from the following detailed description taken with the accompanying drawings.

### BRIEF DESCRIPTION OF THE DRAWINGS

FIG. 1 is a perspective view of a conventional holder for electronic apparatus;

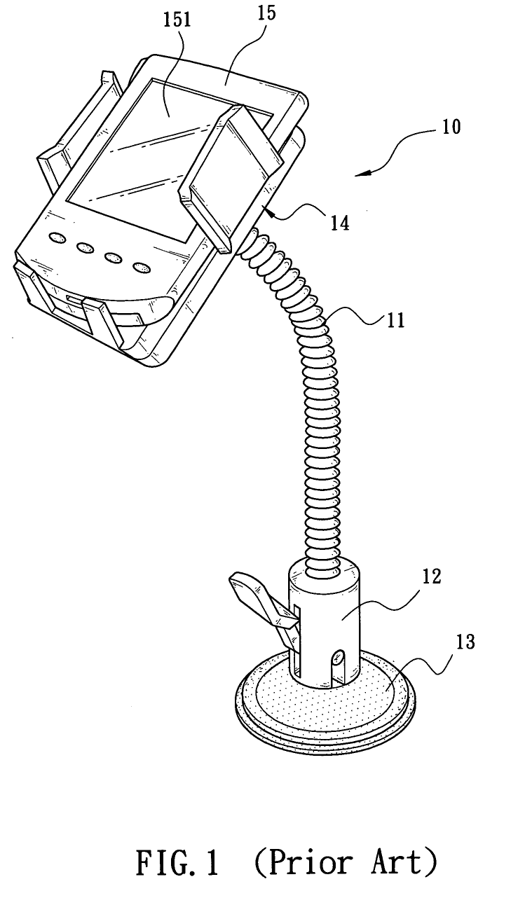

FIG. 2 is an exploded perspective view of a first preferred embodiment of holder for electronic apparatus according to the invention;

FIG. 3 is a first configuration of the holder shown in FIG. 2;

FIG. 4 is a second configuration of the holder shown in FIG. 2;

FIG. 5 is a perspective view of a second preferred embodiment of holder for electronic apparatus according to the invention;

FIG. 6 is an exploded perspective view of a third preferred embodiment of holder for electronic apparatus according to the invention; and

FIG. 7 is a first configuration of the holder shown in FIG. 6.

### DETAILED DESCRIPTION OF THE PREFERRED EMBODIMENTS

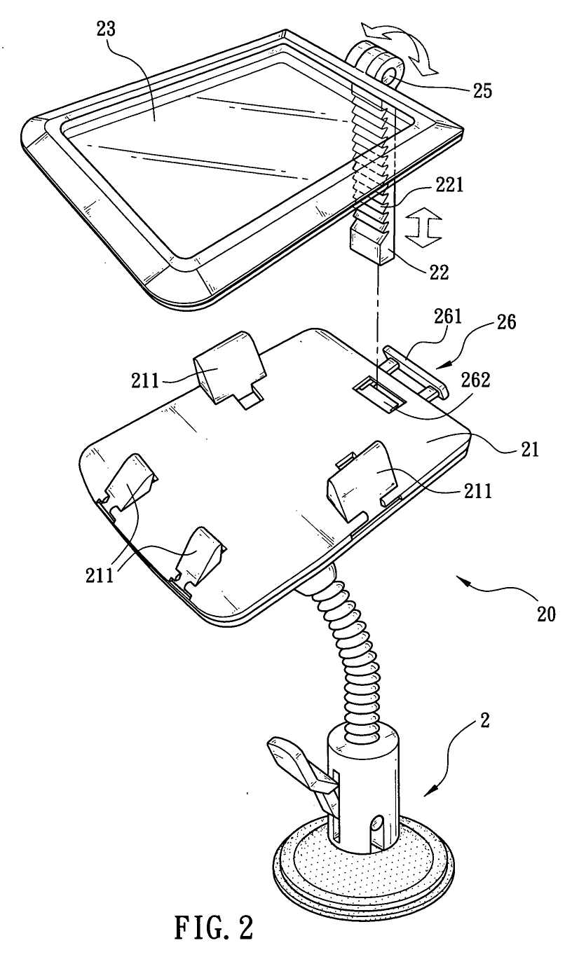

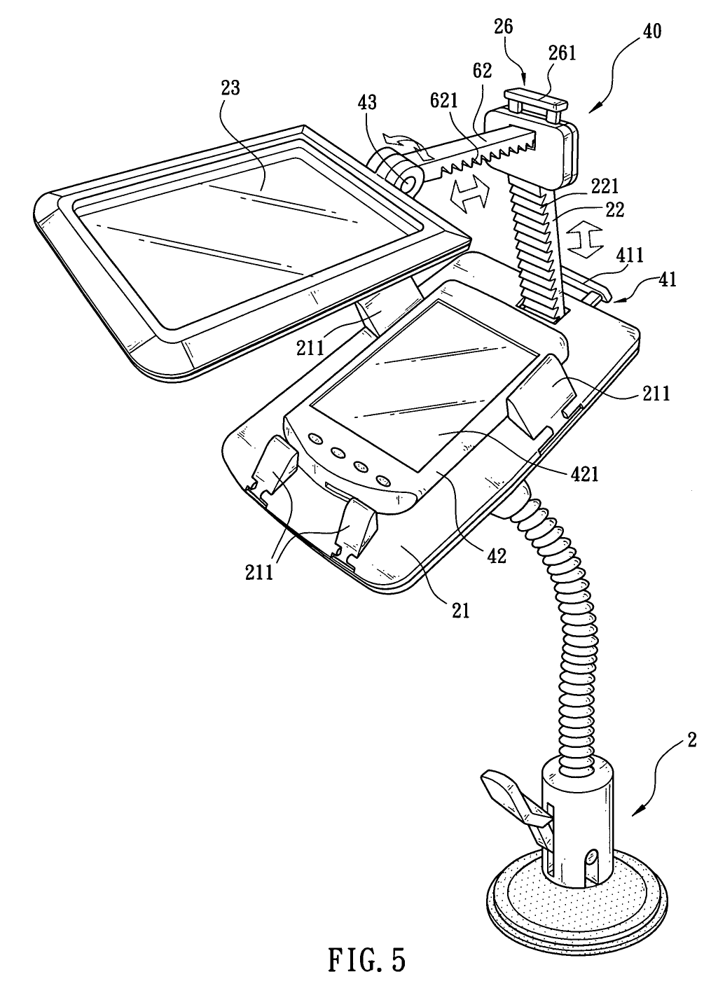

Referring to FIG. 2, there is shown a holder 20 for electronic apparatus according to a first preferred embodiment of the invention. The holder 20 comprises a support 21, a shuttle member 22, and a magnifying glass 23. The underside of the support 21 is attached to a seat 2 secured to a flat surface (e.g., console of an automobile). A top surface of the support 21 is adapted to hold an electronic apparatus 42 (e.g., a PDA or cellular phone as shown in FIG. 5). The shuttle member 22 has one end slidably passed one end of the support 21 and the other end connected to a pivot 25 attached to one end of the magnifying glass 23. Thus, the magnifying glass 23 may turn a predetermined angle about the pivot 25. Also, a catch 26 is provided at one end of the support 21. The catch 26 has a trigger 261 adapted to lockably engage the shuttle member 22 or not for adjusting a distance of the magnifying glass 23 relative to a display 421 of the electronic apparatus 42 on the support 21 (see FIG. 5). As an end, a user can see a magnified, clear display 421 through the magnifying glass 23.

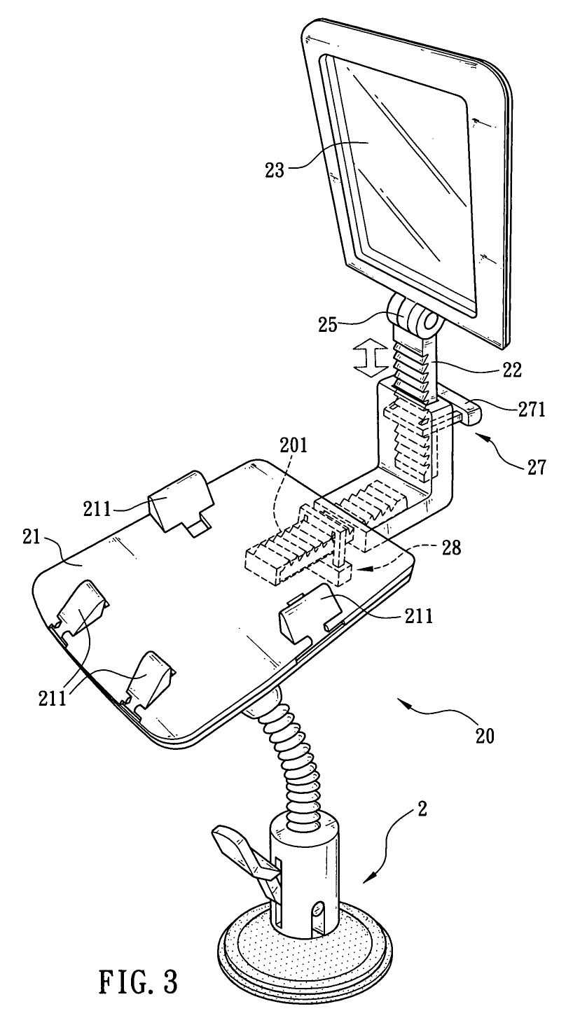

Referring to FIG. 3, it shows a first configuration of the holder 20 shown in FIG. 2. The shuttle member 22 comprises a horizontal portion and a vertical portion. The horizontal portion of the shuttle member 22 can slidably enter a channel 201 within the support 21. A catch 27 is provided at the vertical portion of the shuttle member 22 and has a trigger 271 adapted to lockably engage the vertical portion of the shuttle member 22 or not. A second catch 28 is provided at the channel 201 adapted to lockably engage the horizontal portion of the shuttle member 22 or not. Further, the magnifying glass 23 may turn a predetermined angle about the pivot 25.

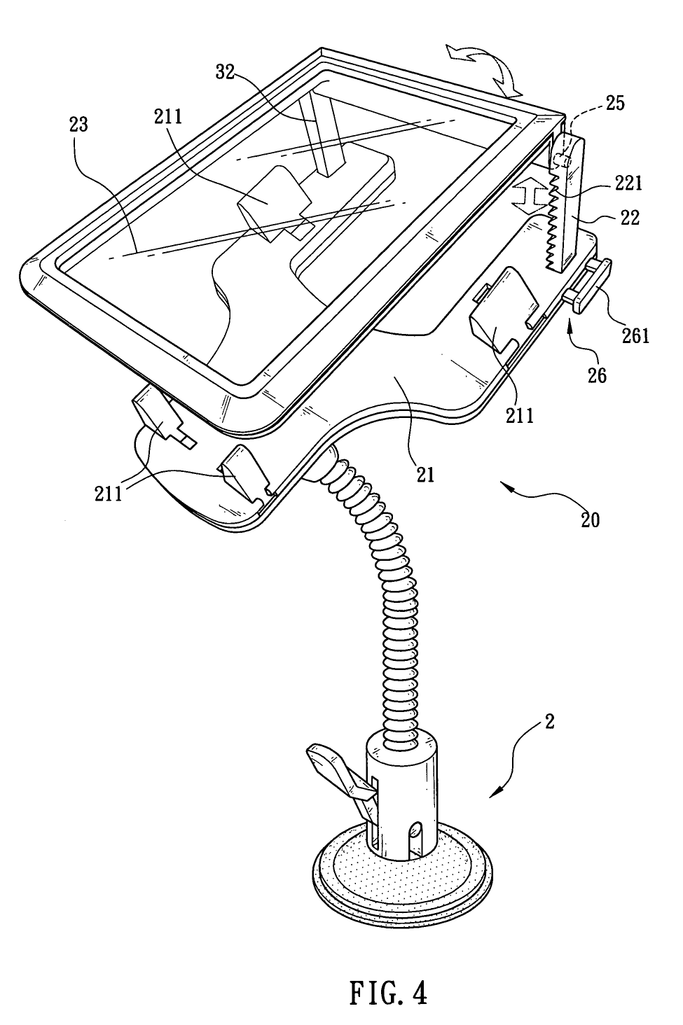

Referring to FIG. 4, it shows a second configuration of the holder 20 shown in FIG. 2. The shuttle member 22 has one end slidably passed one end of the support 21 and the other end connected to one end of a pivot 25. A second shuttle member 32 is formed at the other end of the pivot 25. The second shuttle member 32 has one end passed one branch of a yoke at one end of the support 21 and the other end pivotally connected to the other end of the pivot 25. Thus, the magnifying glass 23 may turn a predetermined angle about the pivot 25. Also, the trigger 261 of the catch 26 is adapted to lockably engage the shuttle member 22 (or the second shuttle member 32) or not for adjusting a distance of the magnifying glass 23 relative to a display 421 of the electronic apparatus 42 on the support 21 (see FIG. 5). As an end, a user can see a magnified, clear display 421 through the magnifying glass 23.

Referring to FIG. 5, a second preferred embodiment of the holder 20 for electronic apparatus according to the invention is shown. The holder 40 comprises a support 21, a shuttle member 22, and a magnifying glass 23. The underside of the support 21 is attached to a seat 2. A top surface of the support 21 is adapted to hold the electronic apparatus 42. The shuttle member 22 has one end slidably passed one end of the support 21 and the other end connected to a catch 26. A second catch 41 is provided at one end of the support 21 (i.e., at the other end of the shuttle member 22). The second catch 41 has a trigger 411 adapted to lockably engage the shuttle member 22 or not. Also, one end of a second shuttle member 62 is slidably passed the catch 26 and the other end thereof is connected to a pivot 43 attached to one end of the magnifying glass 23. Thus, the magnifying glass 23 may turn a predetermined angle about the pivot 43. Also, the catch 26 has a trigger 261 adapted to lockably engage the second shuttle member 62 or not for adjusting a distance of the magnifying glass 23 relative to the shuttle member 22 and adjusting a position of the magnifying glass 23 relative to the display 421 of the electronic apparatus 42 on the support 21. Note that the size of the electronic apparatus 42 may change depending on different types and/or brands. As an end, a user can see a magnified, clear display 421 through the magnifying glass 23.

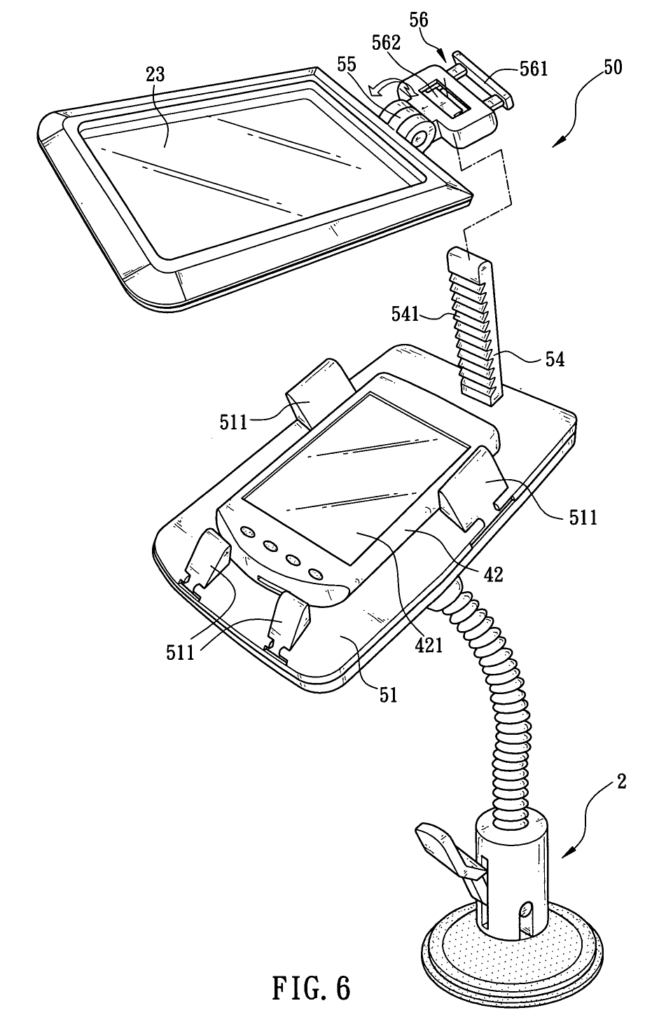

Referring to FIG. 6, a third preferred embodiment of holder 50 for electronic apparatus according to the invention is shown. The holder 50 is also disposed on a seat 2. The holder 50 comprises a support 51 having its underside attached to the seat 2. The support 51 has a flat surface adapted to hold the electronic apparatus 42. A shuttle member 54 is disposed at one end of the support 51. A magnifying glass 23 is also provided and has one end connected to a pivot 55 attached to a catch 56. The other end of the shuttle member 54 passes the catch 56. The catch 56 has a trigger 561 adapted to lockably engage the shuttle member 54 or not.

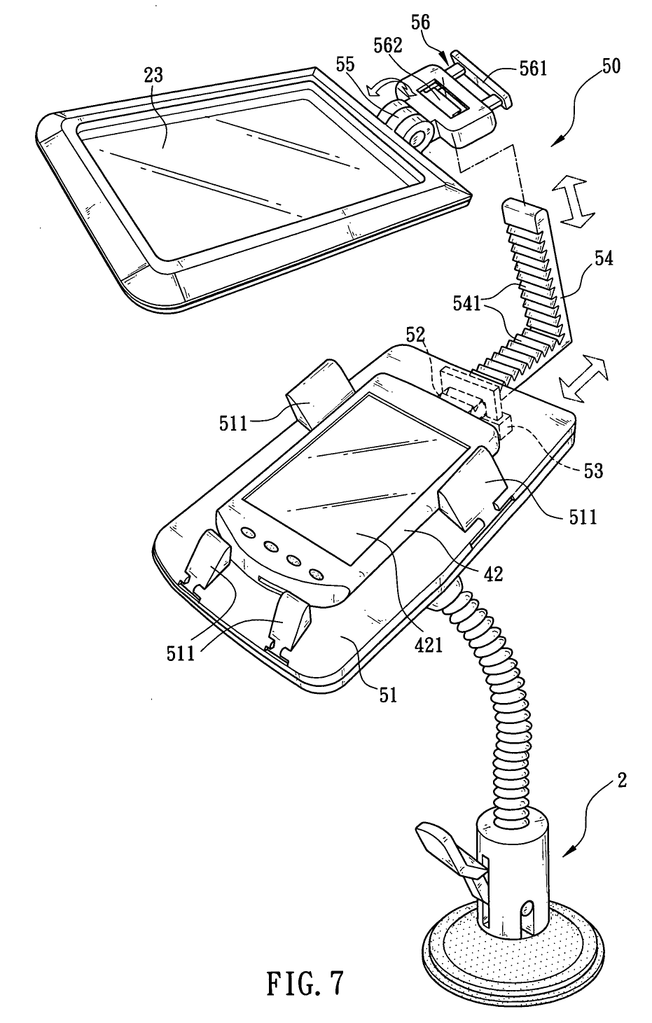

Referring to FIG. 7, it shows a first configuration of the holder 50 shown in FIG. 6. The support 51 at one end comprises a channel 52. A shuttle member 54 comprises a horizontal portion and a vertical portion. The horizontal portion of the shuttle member 54 can slidably enter the channel 52 within the support 51. A second catch 53 is provided at the channel 52 and is adapted to lockably engage the horizontal portion of the shuttle member 54. Note that the size of the electronic apparatus 42 may change depending on different types and/or brands. A pivot 55 is connected to one end of a magnifying glass 23. The magnifying glass 23 thus may turn a predetermined angle about the pivot 55. The pivot 55 is also connected to a catch 56 with the vertical portion of the shuttle member 54 passed. The catch 56 has a trigger 561 adapted to lockably engage the vertical portion of the shuttle member 54 or not. By configuring as above, the magnifying glass 23 also can turn a predetermined angle about the pivot 55. As an end, a user can see a magnified, clear display 421 of the electronic apparatus 42 on the support 51 through the magnifying glass 23.

Referring to FIGS. 2, 3, 4, 5, 6, and 7 again, each of the following members including the shuttle members 22 and 54, the vertical and horizontal portions of the shuttle member 22, the second shuttle member 62, and the vertical and horizontal portions of the shuttle member 54 is formed with a plurality of parallel ridges 221, 621, or 541 adapted to lockably engage a latch 262 of the catch 26, 27, or 56, or a latch 562 of the second catch 28, 41, or 53 (only shown in FIGS. 2, 6, and 7). Moreover, two side sliding clips 511 (or 211) and two end sliding clips 511 (or 211) are formed on the support 51 (or 21) for clamping the electronic apparatus 42.

By configuring the holders 20, 40, and 50 as in the above embodiments, it is clear that a user may secure the holder 20, 40, or 50 to any flat surface by means of the seat 2. Also, the electronic apparatus 42 is firmly held by the support 21 or 51. Further, the catch 26 is adapted to lockably engage one of a plurality of parallel ridges of the shuttle member 62 or not for adjusting a distance of the magnifying glass 23 relative to the display 421 (see FIG. 4). Alternatively, as shown in FIG. 7, the catch 53 is adapted to lockably engage one of a plurality of parallel ridges on the horizontal portion of the shuttle member 54 such that it is possible of adapting the support 51 for firmly holding the electronic apparatus 42. Furthermore, adjusting a distance of the magnifying glass 23 relative to a display 421 of the electronic apparatus 42 will enable a user to see a magnified, clear display 421 through the magnifying glass 23.

In addition, the catch 26, 27, or 56, or the second catch 28, 41, or 53 comprises a catch 261 or 561 (shown in FIGS. 2, 6, and 7 only) and an elastic member (not shown). It is possible of pressing the catch 261 or 561 to compress the elastic member. Thus, the latch 262 or 562 is flexed so as to lockably engage one of the ridges 221, 621, or 541 or not.

While the invention herein disclosed has been described by means of specific embodiments, numerous modifications and variations could be made thereto by those skilled in the art without departing from the scope and spirit of the invention set forth in the claims.

What is claimed is:

1. A holding device comprising:
a support having its underside attached to a seat and a top surface adapted to hold an electronic apparatus;
a shuttle member having one end slidably passed one end of the support; and
a magnifying glass having one end formed as a pivot, the pivot being attached to the other end of the shuttle member,
wherein the magnifying glass is adapted to turn a predetermined angle about the pivot.

2. The holding device of claim 1, further comprising a first catch at one end of the support for lockably engaging the shuttle member.

3. The holding device of claim 2, wherein the shuttle member comprises a plurality of parallel ridges and the first catch comprises a latch adapted to lockably engage one of the ridges of the shuttle member.

4. The holding device of claim 1, wherein the support comprises an internal channel and the shuttle member comprises a vertical portion and a horizontal portion adapted to slidably enter the channel.

5. The holding device of claim 4, further comprising a second catch at the vertical portion of the shuttle member for lockably engaging therewith.

6. The holding device of claim 4, further comprising a third catch at the channel for lockably engaging the horizontal portion of the shuttle member.

7. The holding device of claim 5, wherein the vertical portion of the shuttle member comprises a plurality of parallel ridges and the second catch comprises a latch adapted to lockably engage one of the ridges of the vertical portion of the shuttle member.

8. The holding device of claim 6, wherein the horizontal portion of the shuttle member comprises a plurality of parallel ridges and the third catch comprises a latch adapted to lockably engage one of the ridges of the horizontal portion of the shuttle member.

9. The holding device of claim 1, wherein the shuttle member has one end slidably passed one end of the support and the other end connected to one end of the pivot, and further comprising a second shuttle member having one end passed one of two branches at one end of the support and the other end pivotally connected to the other end of the pivot.

10. The holding device of claim 9, wherein the second shuttle member comprises a plurality of parallel ridges and the first catch comprises a latch adapted to lockably engage one of the ridges of the second shuttle member.

11. The holding device of claim 1, wherein the support comprises two side sliding clips and two end sliding clips for clamping the electronic apparatus held on the top surface of the support.

12. A holding device comprising:
a support having its underside attached to a seat and a top surface adapted to hold an electronic apparatus;
a first shuttle member having one end slidably passed one end of the support;
a second shuttle member;
a first catch at the other end of the first shuttle member;
a second catch at one end of the support for lockably engaging the second shuttle member; and
a magnifying glass having one end formed as a pivot, the pivot being attached to one end of the second shuttle member,
wherein the other end of the second shuttle member passes the first catch such that the first catch is adapted to lockably engage the second shuttle member.

13. The holding device of claim 12, wherein each of the first shuttle member and the second shuttle member comprises a plurality of parallel ridges and each of the second catch and the first catch comprises a latch adapted to lockably engage one of the ridges of the first shuttle member and the second shuttle member respectively.

14. The holding device of claim 13, wherein the support comprises two side sliding clips and two end sliding clips for clamping the electronic apparatus.

15. A holding device comprising:
a support having its underside attached to a seat and a top surface adapted to hold an electronic apparatus;
a shuttle member having one end slidably passed one end of the support;
a catch; and
a magnifying glass having one end formed as a pivot, the pivot being attached to the catch,
wherein the catch passes the other end of the shuttle member for lockably engaging the other end of the shuttle member.

16. The holding device of claim 15, wherein the support comprises a channel at its one end and the shuttle member comprises a vertical portion and a horizontal portion adapted to slidably enter the channel.

17. The holding device of claim 16, further comprising a second catch at the channel for lockably engaging the horizontal portion of the shuttle member.

18. The holding device of claim 16, wherein the vertical portion of the shuttle member comprises a plurality of parallel ridges and the catch comprises a latch adapted to lockably engage one of the ridges of the vertical portion of the shuttle member.

19. The holding device of claim 17, wherein the horizontal portion of the shuttle member comprises a plurality of parallel ridges and the second catch comprises a latch adapted to lockably engage one of the ridges of the horizontal portion of the shuttle member.

20. The holding device of claim 15, wherein the support comprises two side sliding clips and two end sliding clips for clamping the electronic apparatus.
